(19) United States
(12) Patent Application Publication
(10) Pub. No.: US 2024/0282996 A1
(43) Pub. Date: Aug. 22, 2024

(54) chromium bromine flow battery for large scale energy storage

(71) Applicant: Yun Jiang, Toronto (CA)

(72) Inventor: Yun Jiang, Toronto (CA)

(21) Appl. No.: 18/648,450

(22) Filed: Apr. 28, 2024

(51) Int. Cl. H01M 8/18; H01M 8/08

(52) U.S. Cl. CPC H01M 8/188; H01M 8/08; H01M 2300/0005

(57) ABSTRACT

The present invention discloses a rechargeable chromium bromine flow battery, in which anodic chromic ions Cr²⁺ are oxidized to Cr³⁺ while cathodic bromine is reduced to bromide ions Br⁻ during discharge. The process is reversed in charging. The chromium bromine flow battery comprises a carbon anode, a carbon cathode, a proton exchange membrane, and aqueous acidic electrolytes, whereby electricity energy can be stored with high energy density and high power density for large-scale energy storage. Hydrobromic acid of high concentration greater than 4M are used in the electrolytes without any organic complexing agents in the catholyte.

### FIELD OF THE INVENTION

The present invention relates to electrochemical energy storage devices and in particular to the batteries which contain chromic and bromide ions in aqueous acidic electrolytes.

### BACKGROUND OF THE INVENTION

There is an ever-increasing demand for advanced battery technologies with high safety and low cost for applications in large-scale renewable energy storage. The currently commercialized rechargeable batteries, such as Li-ion batteries, have attracted much attention in recent years. However, the safety issues associated with flammable organic electrolytes and the growing concerns about the high cost and availability of Li resources impede their large-scale deployment.

Unlike traditional batteries, flow-based electrochemical energy storage systems separate the energy storage and power generation by storing the electro-active species in externally flowing electrolytes, while maintaining the redox reactions at the electrode surface inside a stack. This unique architecture permits the flow batteries to independently scale the power and energy and enables high safety for intermittent renewable energy integration and other grid services. The most commercialized flow battery up to now is the all-vanadium redox flow battery (VRFB). However, despite continuous progress, the high cost of vanadium makes the installation cost of VRFB much higher than that of Li-ion batteries.

The purpose of this patent is to invent a chromium bromine flow battery to replace VRFB with similar performance characteristics but as low cost as Li-ion batteries. Chromium bromine flow battery (CBFB) was first patented in 1984 (U.S. Pat. No. 4,469,760) but has not been commercialized since then, probably because this CBFB was developed from the zinc-bromine flow battery (ZBFB) and inherited the drawbacks of ZBFB, including the low current and power densities. The bromine complexing agents were used in the CBFB to reduce bromine's vapor pressure in cathodic electrolyte and an anion exchange membrane was used to allow bromide and chloride ions to pass through. The use of organic bromine complexing agents can reduce the concentration of bromine in the cathodic electrolyte and prevent bromine from crossing over the membrane but make the cathodic and anodic electrolytes asymmetric with different ingredients of the complexing agents. The CBFB of this patent uses symmetric electrolytes with high concentration hydrobromic acid but without any complexing agents and uses a cation exchange membrane to allow hydrogen ions to pass through.

### SUMMARY OF THE INVENTION

It is, therefore, an object of the present invention to provide a rechargeable electrochemical battery with similar performances to the VRFB but with lower costs.

This object is achieved in accordance with the present invention by providing a chromium bromine flow battery with a carbon anode, a carbon cathode, a cation exchange membrane for separating anodic electrolyte and cathodic electrolyte, and aqueous acidic electrolytes with 1-3M chromic ions and hydrobromic acid of high concentration greater than 4M.

The said carbon anode and carbon cathode comprise carbon (such as graphite felt, carbon felt, carbon cloth, carbon paper, carbon fiber, and graphite paper).

### BRIEF DESCRIPTION OF THE DRAWINGS

The invention may be more readily understood by reference to the following drawing wherein:

FIG. 1 Chromium bromine flow battery

The referenced drawing is only for the purpose of illustrated embodiments and is not to be construed as limiting the present invention.

### DETAILED DESCRIPTION OF THE INVENTION

The invention discloses a rechargeable chromium bromine flow battery which comprises a carbon anode 1, a carbon cathode 2, a proton exchange membrane 3, and symmetric acidic aqueous 17 electrolytes.

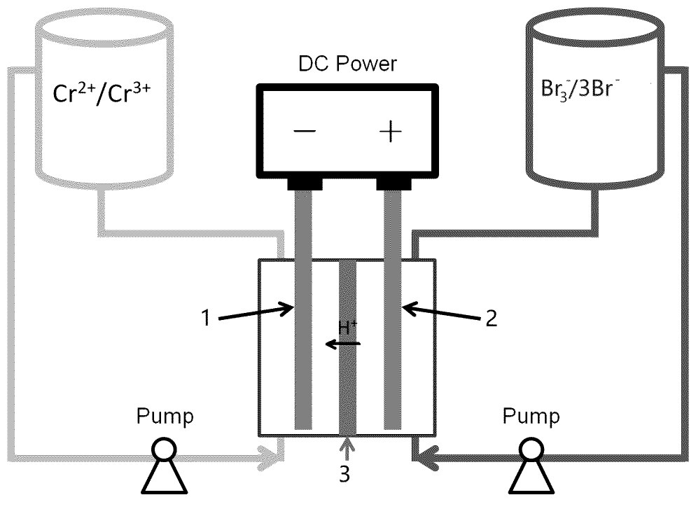

As shown in FIG. 1, in a preferred embodiment, the anodic and cathodic electrolytes are the same containing 2M chromic ions and 5M hydrobromic acid. The proton exchange membrane is Nafion N115. The chromium bromine battery is thus constructed based on the following redox reactions:

| | | |
|---|---|---|
| Anode: | 2 Cr²⁺ − 2 e⁻ ↔ 2 Cr³⁺ | E⁰ = −0.42 V |
| Cathode: | Br₃⁻ + 2e⁻ ↔ 3Br⁻ | E⁰ = +1.09 V |
| Overall: | 2Cr²⁺ + Br₃⁻ ↔ 2Cr³⁺ + 3Br⁻ | E = 1.51 V |

The hydrogen ions in the anodic electrolyte cross through the proton exchange membrane to enter the cathodic electrolyte during the discharging process. During the charging process, the hydrogen ions come back to the anodic electrolyte.

An energy density of 35 Wh/L has been achieved at the current density of 100 mA/cm². This is higher than 25 Wh/L of the all-vanadium flow battery and 15 Wh/L of the iron-chromium redox flow battery (ICRFB). The energy efficiency reaches 82%, higher than 75% of ICRFB, and close to 85% of VRFB. The columbic efficiency can reach 99%, indicating the crossovers of bromine and Cr²⁺ are low and no organic complexing agents are necessary. The capacity decay rate during cycling is only 0.2% per cycle, lower than 0.6% of ICRFB and 0.3% of VRFB. The capacity can be easily restored by mixing the anodic and cathodic electrolytes after a long time of cycling. The costs of chromium and hydrobromic acid are much lower than vanadium. Chromium Cr³⁺/Cr²⁺ is low toxic and the aqueous solution is inflammable, which makes the system safe and environmentally friendly. Although bromine is easy to volatilize, it can be safely sealed in a container without emission.

Although the invention has been described in detail for the purpose of illustration based on the currently considered embodiment, it is to be understood that such detail is solely for that purpose and that the invention is not limited to the disclosed embodiment, but, on the contrary, is intended to cover modifications and equivalent arrangements that are within the spirit and scope of claims.

What is claimed is:

1. A chromium bromine flow battery comprising:
a carbon anode;
a carbon cathode;
a cation exchange membrane;
and
aqueous acidic electrolytes with 1-3M chromic ions and hydrobromic acid of concentration higher than 4M,
whereby electricity energy can be stored.

2. The chromium bromine flow battery of claim 1, wherein said anode and cathode comprise carbon.

3. The chromium bromine flow battery of claim 2, wherein said anode is capable of the following redox reactions:
Cr²⁺-e⁻↔Cr³⁺

4. The chromium bromine flow battery of claim 2, wherein said cathode is capable of the following redox reactions:
Br₃⁻+2e⁻↔3Br⁻

5. The chromium bromine flow battery of claim 1, wherein said cation exchange membrane comprises proton exchange membrane or cation exchange membrane, but no anion exchange membrane.

6. The chromium bromine flow battery of claim 1, wherein said aqueous electrolytes comprises Cr²⁺, Cr³⁺, H⁺ and Br⁻ ions.

7. The chromium bromine flow battery of claim 1, wherein said electrolytes do not comprise any organic complexing agents.
